(19) United States
(12) Patent Application Publication
(10) Pub. No.: US 2017/0115589 A1
(43) Pub. Date: Apr. 27, 2017

(54) TONER, MAGNETIC CARRIERS AND TWO-COMPONENT DEVELOPER

(71) Applicant: Sharp Kabushiki Kaisha, Sakai City (JP)

(72) Inventors: Shoji NAKAI, Sakai City (JP); Takeshi KATOH, Sakai City (JP); Yoritaka TSUBAKI, Sakai City (JP)

(21) Appl. No.: 15/299,933

(22) Filed: Oct. 21, 2016

(30) Foreign Application Priority Data
Oct. 23, 2015 (JP) 2015-208934

(51) Int. Cl. G03G 9/107; G03G 9/08; G03G 9/113; G03G 9/087

(52) U.S. Cl. CPC G03G 9/1075; G03G 9/08755; G03G 9/0819; G03G 9/0821; G03G 9/1136; G03G 9/0808; G03G 9/1138

(57) ABSTRACT

The two-component developer constituted of a toner and carriers, wherein the toner contains a crystalline polyester resin, constituted of a linear saturated aliphatic polyester unit, dispersed in an amorphous polyester resin obtained by polymerizing a bivalent alcohol component monomer and a dicarboxylic acid as an acid component monomer; wherein the carriers have a magnetic property and have core particles covered with a covering layer containing at least a binder resin and aminopropyltriethoxysilane; and

wherein an image of the magnetic carriers photographed by a scanning electron microscope shows the following features:
a percentage of a total area of high-brightness parts derived from a metal oxide on the one magnetic carrier particle to a total projected area is 3.0% by area at the maximum and 80% by piece in the magnetic carriers at the minimum and
an average percentage of the total area of the high-brightness parts derived from the metal oxide on the magnetic carrier particle to the total projected area of the magnetic carriers is 3.0% by area at the maximum.

### CROSS-REFERENCE TO RELATED APPLICATION

This application is related to Japanese Patent Application No. 2015-208934 filed on Oct. 23, 2015, whose priority is claimed under 35 USC §119, and the disclosures of which are incorporated by reference in their entirety.

### BACKGROUND OF THE INVENTION

1. Field of the Invention

The present invention relates to a toner, magnetic carriers and a two-component developer.

2. Description of the Related Art

In recent years, development in office automation equipment has been experiencing remarkable growth, with the result that image forming apparatuses have been widely prevalent, such as copying machines, printers, and facsimile machines, which use an electrophotographic system.

Electrophotographic image forming apparatuses usually form an image through the following steps: charging electrically a surface of a rotary drive photoreceptor uniformly by use of a charger; exposing the charged photoreceptor surface to laser light emitted from an exposure device so as to form an electrostatic latent image on the photoreceptor surface; developing the electrostatic latent image on the photoreceptor surface by use of a developing device using a toner so as to form a toner image on the photoreceptor surface; transferring the toner image on the photoreceptor surface onto a transfer material (recording medium) by use of a transfer device; fixing the toner image by heating a fixing device so as to fix the toner image onto the transfer material.

A residual toner remained on the photoreceptor surface after the image formation operation is removed during a cleaning step by use of a cleaning device and is collected into a pre-mounted recovering device; and a residual electric charge on the photoreceptor surface after the cleaning operation is neutralized during a neutralizing step by use of a neutralization device in order to be ready for the next image formation.

Used as a developer for developing the electrostatic latent image on the photoreceptor surface may be a one-component developer containing a toner only or a two-component developer containing a toner and electrophotographic carriers (hereinafter also referred to as “carriers” or “magnetic carriers”).

The two-component developer has the following functional capabilities because of the carriers: uniform dispersion of the toner, conveyance of the toner, and electrification; and since the toner does not need to function as carriers, and the toner and the carriers have their respective functions, the two-component developer is superior in controllability to the one-component developer, which contains the toner only, and can provide an image with high image quality. For this reason, it has become active to research the toner and the carriers, which constitute the two-component developer, and their combination use.

The carriers have two basic functions: a function of stably charging the toner in a desired electrification amount, and a function of conveying the toner to the photoreceptor. The carriers are stirred inside a developer tank, are conveyed onto a magnetic roller, form magnetic bristles, and are sent back to the developer tank through regulatory blades so as to be used repeatedly. The carriers are thus required to have the stable basic functions, especially the function of stably charging the toner, while being continuously used.

The carriers may bring about carrier uprise depending on their electric properties (electric resistance) and may have a profound effect on image quality such as white spots.

To maintain the basic functions of the carriers, it is suggested that surfaces of carrier cores are covered with a resin covering layer (hereinafter also referred to as “resin layer” or “covering layer”) formed of a styrene-acrylic copolymer resin or a polyurethane resin, both of which are high in surface tension, or a fluorine resin, which is low in surface tension.

Although the resins having the high surface tension have good adhesiveness with the carrier cores, these resins have a problem such that the toner is likely to be spent (exhausted). Although the resin having the low surface tension is effective against the toner-spent, this resin is inferior in adhesiveness with the carrier cores and has a problem such that the resin layer may come off while the carriers are stirred inside the developer tank, resulting in unstable electrification.

To obtain desirable chargeability, Japanese Unexamined Patent Application Publication No. Hei 1(1989)-284862 suggests carriers in which carrier cores are covered with a silicone resin containing an aminosilane coupling agent.

In recent years, electrophotography has been advancing in full-color print; in line with that, improvement of toners has been taking place—for example, improvement of binder resins for dispersing a crystalline polyester resin therein so as to improve low-temperature fixability of the toner.

The toners containing the crystalline polyester resin in the binder resin have some problems such as lower strength than toners containing an amorphous polyester resin only as a binder resin, with the result that the toners containing the crystalline polyester resin are likely to progress toner degradation. It is thought to be caused by the following situations: The toner stirred inside the developer tank for a prolong time causes the cores of the toner to be exposed; the adhesiveness of the toner increases; and the toner is unlikely to be released from a surface of a developing sleeve at a developer releasing member.

If the adhesiveness of the toner increases, a large amount of the toner remains, without being released, at portions (white portions on a sheet of printed paper) on the developing sleeve surface that retain the developer whose toner was not consumed during the image development, compared to portions retaining the developer whose toner was consumed. After the developer is released from the developer releasing member, another developer is overlaid onto the portions on the developing sleeve that retain the developer whose toner was not consumed, causing an increase in toner concentration locally. Such unevenness of the toner concentration in the developer on the developing sleeve causes a ghost phenomenon in which concentration differences occur during the second rotation of the sleeve and thereafter even though the concentration stays invariably after the first rotation of the sleeve.

Accordingly, the two-component developer that contains the toner containing the crystalline polyester excellent in low-temperature fixability requires the carriers for the developer forming the electrostatic latent image that are capable of preventing the ghost phenomenon.

### BRIEF SUMMARY OF THE INVENTION

The present invention has objects of providing carries to be contained in a developer for forming an electrostatic latent image that are capable of preventing a ghost phenomenon and of providing the two-component developer that contains the carriers and a toner that contains a crystalline polyester excellent in low-temperature fixability.

The inventors of the present invention made intensive studies to reach the completion of the present invention such as a two-component developer constituted of a toner and carriers, wherein the toner contains a crystalline polyester resin constituted of a linear saturated aliphatic polyester unit in an amorphous polyester resin obtained by polymerizing a bivalent alcohol component—such as ethylene glycol as a main component—and an acid component monomer—such as a dicarboxylic acid—and wherein the carriers have a magnetic property and have core particles covered with a covering layer containing at least a resin and aminopropyltriethoxysilane; and the above-described problems can be solved by the magnetic carriers having specific characteristics.

The present invention provides a two-component developer constituted of a toner and carriers, wherein the toner contains a crystalline polyester resin, constituted of a linear saturated aliphatic polyester unit, dispersed in an amorphous polyester resin obtained by polymerizing a bivalent alcohol component monomer and a dicarboxylic acid as an acid component monomer;

wherein the carriers have a magnetic property and have core particles covered with a covering layer containing at least a binder resin and aminopropyltriethoxysilane; and
wherein an image of the magnetic carriers photographed by a scanning electron microscope shows the following features:
a percentage of a total area of high-brightness parts derived from a metal oxide on the one magnetic carrier particle to a total projected area is 3.0% by area at the maximum and 80% by piece in the magnetic carriers at the minimum and
an average percentage of the total area of the high-brightness parts derived from the metal oxide on the magnetic carrier particle to the total projected area of the magnetic carriers is 3.0% by area at the maximum.

The present invention provides the two-component developer wherein the bivalent alcohol is ethylene glycol as a main component.

The present invention provides the two-component developer wherein a content of aminopropyltriethoxysilane contained in the surface resin layer of the carriers is 1 to 15 parts by weight with respect to 100 parts by weight of the resin.

The present invention provides the two-component developer wherein an image of the magnetic carriers photographed by the scanning electron microscope shows the following features:

a percentage of a total area of high-brightness parts derived from a metal oxide on one magnetic carrier particle to a total projected area is 3.0% by area at the maximum and 90% by piece in the magnetic carriers at the minimum and
an average percentage of the total area of the high-brightness parts derived from the metal oxide on the magnetic carrier particle to the total projected area of the magnetic carriers is 3.0% by area at the maximum.

The present invention provides the two-component developer wherein a content of aminopropyltriethoxysilane contained in the surface resin layer of the carriers is 5 to 15 parts by weight with respect to 100 parts by weight of the resin.

The present invention provides carriers having core particles covered with a covering layer containing at least a binder resin and aminopropyltriethoxysilane,

wherein an image of the magnetic carriers photographed by a scanning electron microscope shows the following features:
a percentage of a total area of high-brightness parts derived from a metal oxide on one magnetic carrier particle to a total projected area is 3.0% by area at the maximum and 80% by piece in the magnetic carriers at the minimum and
an average percentage of the total area of the high-brightness parts derived from the metal oxide on the magnetic carrier particle to the total projected area of the magnetic carriers is 3.0% by area at the maximum.

The present invention can provide the two-component developer containing the carriers and the toner, the carriers being capable of forming a good image without a ghost phenomenon, and the toner being excellent in low-temperature fixability.

Namely, by using the two-component developer of the present invention, the image having the following features can be stably formed with a low fixing temperature: high definition, good color reproducibility, a high image density, high image quality, low image defect such as a ghost phenomenon.

### BRIEF DESCRIPTION OF THE SEVERAL VIEWS OF THE DRAWINGS

FIG. 1 is a schematic view of a measuring jig to be used for a resistance value measurement of magnetic microparticles.

FIG. 2 is a projection view of magnetic carriers indicated by a 256-level gray scale by use of a scanning electron microscope.

FIG. 3 is a micrograph of particles shown by a size of 1,280×895 obtained from a scanning electron microscope.

FIG. 4 is a micrograph of particles, taken by a scanning electron microscope, from which a low-brightness carbon tape part has been removed and from which magnetic carriers have been extracted.

FIG. 5 is a micrograph of particles, taken by a scanning electron microscope whose brightness is set to range from 140 to 255, from which high-brightness parts on carrier particles have been extracted.

### DETAILED DESCRIPTION OF THE INVENTION

Magnetic carriers of the present invention are formed of magnetic core particles having a conductive property whose surfaces are optimally covered with a covering layer containing a binder resin and aminopropyltriethoxysilane.

In the present invention, an area of high-brightness parts derived from a metal oxide indicates high-brightness parts (where look white and bright on an image) in a visualized image (see FIG. 2) mainly of secondary electrons under a predetermined accelerating voltage of a scanning electron microscope and also indicates magnetic core particle parts observed as the seemingly exposed surfaces of the magnetic carrier particles (in other words, the exposed surfaces or the surfaces covered with the infinitely thin covering layer).

The magnetic carriers of the present invention are capable of achieving the above-described object by specifying a percentage of the area of the high-brightness parts derived from the metal oxide to the magnetic carrier particle surfaces.

The magnetic carriers of the present invention are characterized that a percentage of a total area of the high-brightness parts derived from the metal oxide on one magnetic carrier particle to a total projected area is 3.0% by area at the maximum and 80% by piece in the magnetic carriers at the minimum, and

that an average percentage of the total area of the high-brightness parts derived from the metal oxide on the magnetic carrier particle to the total projected area of the magnetic carriers is 3.0% by area at the maximum.

The above-described magnetic carrier particles contain aminopropyltriethoxysilane in the covering layer on the carrier particle surfaces; and the area of the high-brightness parts derived from the metal oxide is properly controlled; therefore, it is thought that attraction forces between a toner and the carriers can be moderately maintained; and the toner in a developer can be detached from the carriers and prevented from being retained on a developing sleeve at a time when the developer is released from a developer releasing member on the developing sleeve. If the percentage of the total area of the high-brightness parts derived from the metal oxide on one magnetic carrier particle to the total projected area is 3.0% by area at the maximum and 80% by piece in the magnetic carriers at the minimum, and the average percentage of the total area of the high-brightness parts derived from the metal oxide on the magnetic carrier particle to the total projected area of the magnetic carriers is 3.0% by area at the maximum, the above-described effects can be sufficiently obtained.

If the following ranges go beyond, electric charges may flow out of the carrier particles through the high-brightness parts derived from the metal oxide, leading to a ghost phenomenon because of insufficient attraction forces between the toner and the carries: The percentage of the total area of the high-brightness parts derived from the metal oxide on one magnetic carrier particle to the total projected area is 3.0% by area at the maximum and 80% by piece in the magnetic carriers at the minimum, and the average percentage of the total area of the high-brightness parts derived from the metal oxide on the magnetic carrier particle to the total projected area of the magnetic carriers is 3.0% by area at the maximum.

### Toner

In the following, a toner of the present invention will be explained in detail. The toner of the present invention contains a binder resin and an external additive, the binder resin containing an amorphous polyester resin and a crystalline polyester resin, wherein the amorphous polyester resin is obtained by polycondensation of a dicarboxylic monomer—such as terephthalic acid or isophthalic acid as a main component—and a diol monomer—such as ethylene glycol as a main component; wherein the crystalline polyester resin is obtained by polycondensation of a dicarboxylic monomer—such as an aliphatic dicarboxylic acid having 9 to 22 carbon atoms as a main component—and a diol monomer—such as an aliphatic diol having 2 to 10 carbon atoms as a main component; and wherein the external additive may be large-diameter silica microparticles whose primary particle diameter is 75 nm to 220 nm after these microparticles are hydrophobized.

The toner of the present invention comprises toner base particles and the external additive that is externally added to surfaces of the toner base particles, the toner base particles containing the binder resin; and the toner base particles generally contain any of the following internal additives: a detaching agent, colorants, a charge-controlling agent, and others. The toner of the present invention is preferably 5 μm to 10 μm in volume average particle diameter, and more preferably 5.5 μm to 7.5 μm. The toner is 105 to 120° C. in flow softening point.

### Binder Resin

The binder resin to be used for the toner of the present invention contains at least the above-described amorphous polyester resin and crystalline polyester resin. The crystalline polyester resin and the internal additives, such as the detaching agent, the colorants, and the charge-controlling agent, are dispersed in the amorphous polyester resin.

Since the crystalline polyester resin is generally capable of decreasing a softening temperature and a melt viscosity of a toner, it is known that the crystalline polyester resin used with an amorphous polyester resin is capable of improving low-temperature fixability of the toner. In the binder resin to be used for the toner of the present invention, the dicarboxylic monomer contained as the main component in the amorphous polyester resin is different from the dicarboxylic monomer contained as the main component in the crystalline polyester resin—in some cases, the main component of the diol monomer of the amorphous polyester resin is different from the main component of the diol monomer of the crystalline polyester resin—and this makes compatibility of these polyester resins firmly suppressed, resulting in high enhancement of the low-temperature fixability. The suppressed compatibility of these polyester resins, however, causes the crystalline polyester resin to be readily released from the amorphous polyester resin and to be readily fixed on a developing roller together with the large-diameter silica. It is thus highly effective to use, as the external additive, the large-diameter silica microparticles whose primary particle diameter is 75 nm to 220 nm after these microparticles are hydrophobized.

The monomer used for the polyester may be any of those known as polyester dicarboxylic acids that are commonly used in the relevant technical field; and examples of the monomer include aromatic carboxylic acids such as terephthalic acid, isophthalic acid, phthalic anhydride, pyromellitic acid, and naphthalenedicarboxylic acid; aliphatic carboxylic acids such as maleic anhydride, fumaric acid, succinic acid, alkenyl anhydrous succinic acid, and adipic acid; and lower alkyl esters of these polybasic acids such as ester compounds including methyl, ethyl, n-propyl, i-propyl, and t-butyl.

The above-described dicarboxylic acids may be used independently, or two or more kinds may be used in combination.

In addition to the dicarboxylic acid, a tricarboxylic acid may be used, such as trimellitic acid or anhydrous trimellitic acid.

Used as the bivalent alcohol may be any of those known as monomers for polyester; and examples of the bivalent alcohol include aliphatic polyols such as ethylene glycol, propylene glycol, butanediol, hexanediol, neopentyl glycol, and glycerin; alicyclic polyols such as cyclohexanediol, cyclohexane dimethanol, and hydrogenated bisphenol A; and aromatic diols such as ethylene oxide adducts of bisphenol A and propylene oxide adducts of bisphenol A.

The bivalent alcohols may be used independently, or two or more kinds may be used in combination.

A polycondensation reaction of the dicarboxylic acid and the bivalent alcohol may be carried out in the usual manner; for example, the dicarboxylic acid and the bivalent alcohol may be polymerized in the presence of an organic solvent and a polycondensation catalyst.

The polymerization reaction may be stopped at a time when an acid value or a softening temperature of a polyester resin to be prepared reaches to a predetermined value.

This is how the polyester resin is obtained.

In some cases, the organic solvent may not necessarily be used.

In a case where a methyl esterified compound of dicarboxylic acid is used as a part of the dicarboxylic acid, de-methanol polycondensation reaction is carried out. If the dicarboxylic acid and the bivalent alcohol are properly changed in ratio and reaction rate during this polycondensation reaction, a content of the carboxyl group at end of the polyester may be adjusted, leading to changes in characteristics of the polyester.

It is preferable that the polycondensation of the bivalent alcohol component and the dicarboxylic component should be carried out in the presence of an esterification catalyst. Excellent examples of the esterification catalyst in the present invention include titanium compounds and inorganic tin (II) compounds; and these compounds may be used independently, or two respective compounds may be used in combination. The titanium compounds having a Ti—O bond are preferable; and those having an alkoxy group, an alkenyloxy group, or an acyloxy group with 1 to 28 carbon atoms in total are more preferable.

Used as the alkoxy group with 1 to 28 carbon atoms in total is, for example, a methoxy group, an ethoxy group, an isopropyl alkoxy group, a t-butyl alkoxy group, or a pentoxy group.

In the present invention, the main component of the dicarboxylic monomer indicates a monomer having a largest molar content rate among all monomers that form the dicarboxylic monomer; and the same applies to the main component of the diol monomer; and additionally, this includes cases where one monomer involves (namely, cases where a molar content rate of terephthalic acid, isophthalic acid, ethylene glycol, an aliphatic dicarboxylic acid having 9 to 22 carbon atoms, or an aliphatic diol having 2 to 10 carbon atoms is 100%).

A mass ratio between the crystalline polyester resin and the amorphous polyester resin in the binder resin contained in the toner of the present invention is not particularly limited and may be adjusted as appropriate; however, it is preferred that the mass ratio is 3:97 to 30:70 from the viewpoint of low-temperature fixability and hot offset resistance. If the mass ratio of the crystalline polyester resin becomes lower than 3%, the hot offset resistance may increase, whereas the low-temperature fixability may become impaired. If the mass ratio of the crystalline polyester resin becomes higher than 30%, the low-temperature fixability may increase, whereas the hot offset resistance may become impaired.

In the present invention, amorphous resins and crystalline resins are distinguished from each other by a crystallization index; and resins having the crystallization index in a range from 0.6 to 1.5 are considered as the crystalline resins, whereas resins having the crystallization index of less than 0.6 or of more than 1.5 are considered as the amorphous resin. The resins having the crystallization index of more than 1.5 are considered to be amorphous, whereas the resins having the crystallization index of less than 0.6 are low in crystallinity and high in amorphous parts.

A crystallization index is a physical property to be used as an indicator of degrees of the resin crystallization and is defined by a ratio between a softening temperature and an endothermic maximum peak temperature (softening temperature/endothermic maximum peak temperature). The endothermic maximum peak temperature is a peak temperature at its maximum on the high temperature side among endothermic peak temperatures observed. The maximum peak temperature of the crystalline polyester resin is considered as a melting point, and the peak temperature at its maximum on the high temperature side of the amorphous polyester resin is considered as a glass-transition point.

The degrees of the resin crystallization may be controlled by adjusting types and a ratio of material monomers and also manufacturing conditions (such as reaction temperatures, a reaction time, and a cooling rate).

### Amorphous Polyester Resin

The amorphous polyester resin to be used for the toner of the present invention is obtained by the polycondensation of the dicarboxylic monomer—such as terephthalic acid or isophthalic acid as the main component—and the diol monomer—such as ethylene glycol as the main component.

The dicarboxylic monomer to be used to synthesize the amorphous polyester resin may be terephthalic acid or isophthalic acid as the main component. The molar content rate of terephthalic acid or isophthalic acid of the dicarboxylic monomer is preferably 70% or higher and 100% or lower, and more preferably 80% or higher and 100% or lower.

Used as the dicarboxylic monomer may be an aromatic dicarboxylic acid or an aliphatic dicarboxylic acid other than terephthalic acid and isophthalic acid. Examples of the aromatic dicarboxylic acid other than terephthalic acid and isophthalic acid include fumaric acid; and examples of the aliphatic dicarboxylic acid include adipic acid, sebacic acid, and succinic acid. The dicarboxylic monomer may also be an ester-forming derivative of terephthalic acid or isophthalic acid, an ester-forming derivative of the aromatic dicarboxylic acid other than terephthalic acid and isophthalic acid, or an ester-forming derivative of the aliphatic dicarboxylic acid. In the present invention, the ester-forming derivatives may be, for example, acid anhydrides of the carboxylic acids and alkyl esters. In a case where the dicarboxylic monomer except for terephthalic acid and isophthalic acid is used, the above-described dicarboxylic monomers may be used independently, or two or more kinds may be used in combination.

To synthesize the amorphous polyester resin, a trivalent or higher polycarboxylic monomer may be used together with the dicarboxylic monomer. Used as the trivalent or higher polycarboxylic monomer may be a trivalent or higher polycarboxylic acid, such as trimellitic acid or pyromellitic acid, or its ester-forming derivative. In a case where the trivalent or higher polycarboxylic monomer is used, the above-described polycarboxylic monomers may be used independently, or two or more kinds may be used in combination.

The diol monomer to be used to synthesize the amorphous polyester resin may be ethylene glycol as the main component. The molar content rate of ethylene glycol of the diol monomer is preferably 70% or higher and 100% or lower, and more preferably 80% or higher and 100% or lower.

The diol monomer may also be 1,3-propylene glycol, 1,4-butanediol, or the like. In a case where the diol monomer except for ethylene glycol is used, the above-described diol monomers may be used independently, or two or more kinds may be used in combination.

The amorphous polyester resin to be used for the toner of the present invention may be prepared in the same manner as a conventional polyester preparation method. For example, the amorphous polyester resin may be synthesized by a polycondensation reaction of the dicarboxylic monomer and the diol monomer and possibly the trivalent or higher polycarboxylic monomer in an atmosphere of a nitrogen gas at 190 to 240° C.

For the polycondensation reaction, a reaction ratio between the diol monomer and the carboxylic monomer (such as the dicarboxylic monomer and possibly the trivalent or higher polycarboxylic monomer) is preferably 1.3:1 to 1:1.2 as an equivalent ratio [OH]:[COOH] of a hydroxyl group and a carboxyl group. For the polycondensation reaction, a molar content rate of the dicarboxylic monomer in the carboxylic monomer is preferably 80 to 100%. For the polycondensation reaction, the esterification catalyst, such as dibutyltin oxide or titanium alkoxide (for example, tetrabutoxy titanate), may be used as needed.

A glass-transition temperature (T_{g}) of the amorphous polyester resin is preferably 50 to 70° C. from the viewpoint of fixability, storage stability, durability, and others. If the glass-transition temperature goes beyond this range, the fixability, the storage stability, and the durability may become out of balance.

A softening point (Tₘ) of the amorphous polyester resin is preferably 100 to 150° C. from the viewpoint of low-temperature fixability and hot offset resistance. If the softening point goes beyond this range, the low-temperature fixability and the hot offset resistance may become out of balance.

A molecular weight of the amorphous polyester resin is preferably 3,000 to 10,500 from the viewpoint that a peak top molecular weight (Mᵣ) of a tetrahydrofuran (THF) soluble part measured by a gel permeation chromatography (GPC) controls a balance of heat resistance, heat storage stability, and low-temperature fixability of the toner. If the peak top molecular weight goes beyond the range of 3,000 to 10,500, the balance of the heat resistance, the heat storage stability, and the low-temperature fixability of the toner may become imbalance.

GPC uses tetrahydrofuran (THF) as a mobile phase, and also uses polystyrene as a standard substance. The peak top molecular weight indicates a molecular weight at a highest peak height in a chromatogram obtained by the GPC measurement.

An acid value of the amorphous polyester resin is preferably 0 to 60 mg KOH/g from the viewpoint of charging characteristics, and a hydroxyl value of the amorphous polyester resin is preferably 0 to 50 mg KOH/g from the viewpoint of the hot offset resistance. If the acid value becomes higher than 60 mg KOH/g, the charging efficiency may become degraded; and if the hydroxyl value becomes higher than 50 mg KOH/g, the hot offset resistance may become insufficient.

A solubility parameter (SP) value of the amorphous polyester resin is preferably 10.5 to 12.5.

A content of the amorphous polyester resin in the toner of the present invention is not particularly limited; however, the content is preferably 70 to 97% by mass in the toner base particles.

### Crystalline Polyester Resin

The crystalline polyester resin to be used for the toner of the present invention is obtained by the polycondensation of the dicarboxylic monomer—such as the aliphatic dicarboxylic acid having 9 to 22 carbon atoms as the main component—and the diol monomer—such as the aliphatic diol having 2 to 10 carbon atoms as the main component—and contains a linear saturated aliphatic polyester unit. Because of containing the linear saturated aliphatic polyester unit, the crystalline polyester resin is not likely to be compatible with the amorphous polyester resin.

The dicarboxylic monomer to be used to synthesize the crystalline polyester resin may be the aliphatic dicarboxylic acid having 9 to 22 carbon atoms as the main component. A molar content rate of the aliphatic dicarboxylic acid having 9 to 22 carbon atoms of the dicarboxylic monomer is preferably 80% or higher and 100% or lower.

Examples of the aliphatic dicarboxylic acid having 9 to 22 carbon atoms include azelaic acid, sebacic acid, 1,10-decane dicarboxylic acid, and 1,18-octadecane dicarboxylic acid. The dicarboxylic monomer may also be ester-forming derivatives of these aliphatic dicarboxylic acids. These dicarboxylic monomers may be used independently, or two or more kinds may be used in combination.

To synthesize the crystalline polyester resin, a trivalent or higher polycarboxylic monomer may be used together with the dicarboxylic monomer. Used as the trivalent or higher polycarboxylic monomer may be a trivalent or higher polycarboxylic acid, such as trimellitic acid or pyromellitic acid, or its ester-forming derivative. In a case where the trivalent or higher polycarboxylic monomer is used, the above-described polycarboxylic monomers may be used independently, or two or more kinds may be used in combination.

The diol monomer to be used to synthesize the crystalline polyester resin may be the aliphatic diol having 2 to 10 carbon atoms as the main component. A molar content rate of the aliphatic diol having 2 to 10 carbon atoms of the diol monomer is preferably 80% or higher and 100% or lower.

Examples of the aliphatic diol having 2 to 10 carbon atoms include ethylene glycol, 1,4-butanediol, and 1,6-hexanediol. These diol monomers may be used independently, or two or more kinds may be used in combination.

To synthesize the crystalline polyester resin, a trivalent or higher polyol monomer may be used together with the diol monomer. Used as the trivalent or higher polyol monomer may be glycerin, trimethylol propane, or the like. In a case where the trivalent or higher polyol monomer is used, the above-described polyol monomers may be used independently, or two or more kinds may be used in combination.

The crystalline polyester resin to be used for the toner of the present invention may be prepared in the same manner as a conventional polyester preparation method. For example, the crystalline polyester resin may be synthesized by a polycondensation reaction of the dicarboxylic monomer and the diol monomer and possibly the trivalent or higher polycarboxylic monomer and/or the trivalent or higher polyol monomer in an atmosphere of a nitrogen gas at 190 to 240° C.

For the polycondensation reaction, an equivalent ratio (OH group/COOH group) between the hydroxyl group of the polyol monomer (such as the diol monomer and possibly the trivalent or higher polyol monomer) and the carboxyl group of the carboxylic monomer (such as the dicarboxylic monomer and possibly the trivalent or higher polycarboxylic monomer) is preferably 0.83 to 1.3 from the viewpoint of the storage stability and others. For the polycondensation reaction, a molar content rate of the dicarboxylic monomer of the carboxylic monomer is preferably 90 to 100%. The lower the molar content rate of the dicarboxylic monomer is, the lower a percentage and a speed of the crystallization is, resulting in insufficient toner aggregation resistance. For the polycondensation reaction, a molar content rate of the diol monomer of the polyol monomer is preferably 80 to 100%. For the polycondensation reaction, the esterification catalyst, such as dibutyltin oxide or titanium alkoxide (for example, tetrabutoxy titanate), may be used as needed.

A melting point (Tₘₚ) of the crystalline polyester resin is preferably 40° C. or higher, and more preferably 60 to 90° C. from the viewpoint of the fixability, the storage stability, the durability, and others. If the melting point becomes lower than 40° C., the durability may become insufficient. If the melting point becomes 90° C. or higher, the fixability may become insufficient.

A softening point (Tₘ) of the crystalline polyester resin is preferably 65 to 110° C. from the viewpoint of the low-temperature fixability and blocking resistance. If the softening point goes beyond this range, the low-temperature fixability and/or the blocking resistance may become insufficient.

A ratio (Tₘ/Tₘₚ) between the softening point (Tₘ) and the melting point (Tₘₚ) of the crystalline polyester resin is preferably 1.0 to 1.4 from the viewpoint of the crystallization speed and the blocking resistance. If the ratio between the softening point and the melting point goes beyond this range, the crystallization speed and/or the blocking resistance may become insufficient.

A molecular weight of the crystalline polyester resin is preferably 10,000 to 90,000 from the viewpoint that a peak top molecular weight (Mₚ) of a tetrahydrofuran (THF) soluble part measured by a gel permeation chromatography (GPC) controls storage stability, low-temperature fixability, and others. The GPC uses tetrahydrofuran (THF) as a mobile phase, and also uses polystyrene as a standard substance. The peak top molecular weight indicates a highest peak height of the molecular weight in a chromatogram obtained by the GPC measurement. If the peak top molecular weight goes beyond the above-mentioned range, the storage stability and/or the low-temperature fixability may become insufficient.

An acid value of the crystalline polyester resin is preferably 0 to 60 mg KOH/g from the viewpoint of charging characteristics, and a hydroxyl value of the crystalline polyester resin is preferably 0 to 40 mg KOH/g from the viewpoint of the hot offset resistance. If the acid value becomes higher than 60 mg KOH/g, the charging efficiency may become degraded; and if the hydroxyl value becomes higher than 40 mg KOH/g, the hot offset resistance may become insufficient.

A solubility parameter (SP) value of the crystalline polyester resin is preferably 9.3 to 10.0. If the SP value becomes lower than 9.3, the crystalline polyester resin may become too low in compatibility with the amorphous polyester resin, and the durability may become insufficient. If the SP value exceeds 10.0, the glass-transition temperature T_{g} of the binder resin may decrease, and the blocking resistance may decrease.

In the toner of the present invention, a content of the crystalline polyester resin is not particularly limited; however, its content is preferably 3 to 30% by mass in the toner base particles.

### Detaching Agent

To give detachability to the toner, the detaching agent is added to the toner at a time when the toner fixes to a recording medium. In the toner of the present invention, the detaching agent is dispersed in the amorphous polyester resin.

The detaching agent to be added to the toner of the present invention is not particularly limited; and any detaching agent commonly used in the relevant field may be used, such as polypropylene wax, polyethylene wax and its derivatives, microcrystalline wax, carnauba wax, rice wax, candelilla wax, or synthetic ester-based wax. Used as the synthetic ester-based wax is, for example, Nissan Electol wax (WEP-2, WEP-3, WEP-4, WEP-5, WEP-6, WEP-7, WEP-8, WEP-9, or WEP-10 manufactured by NOF Corporation).

In the toner of the present invention, a content of the detaching agent is not particularly limited; however, its content is preferably 1 to 5% by mass in the toner base particles.

### Colorants

Used as the colorants may be any publicly known pigments or dyes that are commonly used in the toner. More specifically, the following colorants may be used.

Used as a colorant for a black toner may be, for example, carbon black or magnetite.

Used as the colorant for a yellow toner may be, for example, an acetoacetic arylamide-based monoazo yellow pigment such as C.I. pigment yellow 1, C.I. pigment yellow 3, C.I. pigment yellow 74, C.I. pigment yellow 97, or C.I. pigment yellow 98; an acetoacetic arylamide-based disazo yellow pigment such as C.I. pigment yellow 12, C.I. pigment yellow 13, C.I. pigment yellow 14, or C.I. pigment yellow 17; a condensed monoazo-based yellow pigment such as C.I. pigment yellow 93 or C.I. pigment yellow 155; other yellow pigment such as C.I. pigment yellow 180, C.I. pigment yellow 150, or C.I. pigment yellow 185; or a yellow dye such as C.I. solvent yellow 19, C.I. solvent yellow 77, C.I. solvent yellow 79, or C.I. disperse yellow 164.

Used as the colorant for a magenta toner may be, for example, a red or pink pigment such as C.I. pigment red 48, C.I. pigment red 49:1, C.I. pigment red 53:1, C.I. pigment red 57, C.I. pigment red 57:1, C.I. pigment red 81, C.I. pigment red 122, C.I. pigment red 5, C.I. pigment red 146, C.I. pigment red 184, C.I. pigment red 238, or C.I. pigment violet 19; or a red dye such as C.I. solvent red 49, C.I. solvent red 52, C.I. solvent red 58, or C.I. solvent red 8.

Used as the colorant for a cyan toner may be, for example, a blue pigment of copper phthalocyanine or its derivatives such as C.I. pigment blue 15:3 or C.I. pigment blue 15:4, or a green pigment such as C.I. pigment green 7 or C.I. pigment green 36 (phthalocyanine green).

In the toner of the present invention, contents of the colorants are not particularly limited; however, their contents are preferably 2 to 10% by mass in the toner base particles.

### Charge-Controlling Agent

The charge-controlling agent is added to the toner so as to give desirable chargeability to the toner. The charge-controlling agent to be used in the toner of the present invention is to control a positive electric charge or a negative electric charge.

Examples of the charge-controlling agent for controlling the positive electric charge include a nigrosine dye and its derivatives, triphenylmethane derivatives, quaternary ammonium salt, quaternary phosphonium salt, quaternary pyridinium salt, guanidine salt, and amidine salt.

Examples of the charge-controlling agent for controlling the negative electric charge include a chrome azo complex dye, an iron azo complex dye, a cobalt azo complex dye, chrome-zinc-aluminum-boron complex or chloride of salicylic acid or its derivatives, chrome-zinc-aluminum-boron complex or chloride of naphthol acid or its derivatives, chrome-zinc-aluminum-boron complex or chloride of benzilic acid or its derivatives, long-chain alkyl-carboxylate, and long-chain alkyl-sulfonate. In the toner of the present invention, a content of the charge-controlling agent is not particularly limited; however, its content is preferably 0.5 to 5% by mass in the toner base particles.

The charge-controlling agents may be used independently, or two or more kinds may be used in combination as the need arises.

### External Additive

The external additive may be added to the toner of the present invention.

Used as the external additive may be any of external additives that are commonly used in the relevant technical field; and examples of the external additive include silica, titanium oxide, silicon carbide, aluminum oxide, and barium titanate. It is, however, preferable that the external additive should be subjected to a surface treatment (a hydrophobizing treatment) with a silicone resin or a silane coupling agent, from the viewpoint that the toner particles should be prevented from adhering to each other.

In the present invention, the above-described external additives may be used independently, or two or more kinds may be used in combination.

In the present invention, it is preferable that several kinds of the external additives should be used that are different in average particle diameter. From the viewpoint of improving transcription efficiency, it is preferable that the at least one kind out of the several kinds of the external additives should be 0.1 μm or more in average particle diameter and that the several kinds of the external additives should be 0.2 μm or less in average particle diameter.

In a case where two kinds of the external additives are used that are different in average particle diameter, it is preferable that the smaller one of the two kinds should be 0.007 to 0.5 μm in average particle diameter and that the larger one should be 0.5 to 2.0 μm in average particle diameter; and it is preferable that a ratio of the average particle diameter between the smaller one and the larger one should be 1:5 to 1:20.

A content of the external additive is not particularly limited; however, its content is preferably 0.1 to 3.0 parts by weight with respect to 100 parts by weight of the toner base particles; and it is particularly preferable that its content should be 0.5 to 1.0 parts by weight.

The external additive having the content within the above-described range enables a formed image to have a high image density and high image quality without losing the various physical properties of the toner.

### Toner Preparation Method

In the following, a method for preparing the toner of the present invention will be explained. The toner of the present invention may be prepared by a publicly known method such as a kneading-grinding method or a condensation method. For example, to prepare a toner of the present invention by the kneading-grinding method, a binder resin containing an amorphous polyester resin and a crystalline polyester resin is mixed with internal additives, such as a detaching agent, a colorant, and a charge-controlling agent that may be properly selected as needed, by use of an airflow mixer, such as a Henschel mixer; the obtained raw material mixture is kneaded at about 100 to 180° C. by use of a melt-kneading machine, such as a two-axis kneading machine or an open roll kneader. The obtained molten-kneaded mixture is cooled and solidified; and the solidified product is milled by use of an air-type milling machine, such as a jet mill, and is subjected to size control, such as classifying, as needed, so as to prepare toner base particles. A common practice of how to add an external additive is to mix the toner base particles with the external additive by use of an airflow mixer, such as a Henschel mixer.

### Carriers

The carriers of the present invention are constituted of carrier cores having a resin covering layer on their surfaces that are treated with and covered with a binder resin and an aminosilane coupling agent. Carrier Cores (also known as “core particles”)

The carrier cores are not particularly limited; and any carrier cores commonly used in the relevant technical field may be used—for example, a magnetic metal such as iron, copper, nickel, or cobalt, or a magnetic metal oxide such as ferrite or magnetite. Any of these carrier cores may become suitable carriers for a developer to be used in a magnetic brush development method.

Of these carrier cores, the particles containing the ferrite component are preferable. The ferrite is high in saturated magnetization and can serve as low-density coat carriers; and the developer containing the ferrite is not thus likely to cause adhesion of the coat carriers to a photoreceptor, with the result that a soft magnetic brush may be formed, and an image that is high in dot reproduction may be formed.

Examples of the ferrite include zinc-based ferrite, nickel-based ferrite, copper-based ferrite, barium ferrite, strontium ferrite, nickel-zinc-based ferrite, manganese-magnesium-based ferrite, copper-magnesium-based ferrite, manganese-zinc-based ferrite, manganese-copper-zinc-based ferrite, and manganese-magnesium-strontium-based ferrite.

The ferrite may be prepared by any publicly known method. For example, ferrite materials are mixed, such as Fe₂O₃ and Mg(OH)₂; this mixed powder is tentatively heated by a furnace. This heated product is cooled and then milled by use of a vibrational mill until being about 1 μm particles; and a dispersant and water are added to the milled powder so as to obtain a slurry. This slurry is subjected to wet crushing in a wet ball mill, and the obtained suspension is dried by a spray dryer until being pelletized so as to obtain ferrite particles.

The carrier cores are preferably 25 to 100 μm in average particle diameter, and more preferably 25 to 90 μm.

The carrier cores having the average particle diameter within the above-described range enable the toner to be stably conveyed to an electrostatic latent image formed on the photoreceptor, and are capable of forming high-definition images over a prolonged period.

If the average particle diameter of the carrier cores is less than 25 μm, it may be difficult to control the carrier adhesion. If the average particle diameter of the carrier cores exceeds 100 μm, high-definition images may not be formed.

### Resin to be Contained in Carriers

A resin to form a resin layer is not particularly limited; and any resin commonly used in the relevant technical field may be used, such as a polyester resin, an acrylic resin, an acrylic denatured resin, a silicone resin, or a fluorine resin.

In the present invention, the above-described resins may be used independently, or two or more kinds may be used in combination.

Examples of the acrylic resin include polyacrylate, polymethylmethacrylate, polyethylmethacrylate, poly-n-butylmethacrylate, polyglycidylmethacrylate, fluorine-containing polyacrylate, styrene-methacrylate copolymer, styrene-butylmethacrylate copolymer, styrene-ethyl acrylate copolymer.

Examples of the commercially available acrylic resin include Dianal SE-5437 manufactured by Mitsubishi Rayon Co., Ltd., S-LEC PSE-0020 manufactured by Sekisui Chemical Co., Ltd., Himer ST95 manufactured by Sanyo Chemical Industries, Co., Ltd., and FM601 manufactured by Mitsui Chemicals, Inc.

The silicone resin is capable of suppressing toner-spent and of improving adhesiveness between the carrier cores and the resin layer, and a crosslinking silicone resin is preferable.

The crosslinking silicone resin may be any of known silicone resins, as indicated below, that are crosslinked by a chemical reaction such as a heating dehydration reaction between Si atom-bonding hydroxyl groups or between a hydroxyl group and an OX group, or a room-temperature curing reaction.

### Thermal Dehydration Reaction

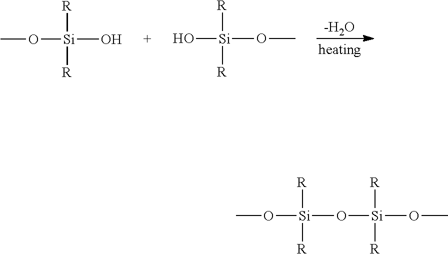

### Cold Curring Reaction

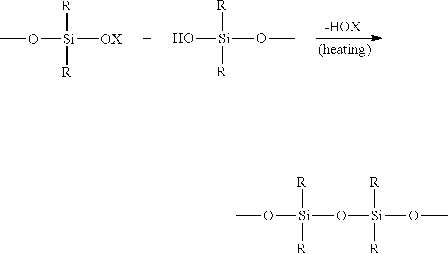

wherein the substituents Rs may be the same or different and represent a monovalent organic group; and the OX group represents an acetoxy group, an aminoxy group, an alkoxy group, an oxime group, or the like.

Used as the crosslinking silicone resin may be a thermosetting silicone resin or a room-temperature-setting silicone resin. To crosslink the thermosetting silicone resin, the resin is heated at about 200 to 250° C. To cure the room-temperature-setting silicone resin, heating is not necessary; however, the silicone resin may be heated at 150 to 280° C. in order to shorten a curing time.

In the crosslinking silicone resins, the monovalent organic group represented by R is preferably a methyl group. Since this crosslinking silicone resin has a minute crosslinking structure, the carriers covered with the resin layer containing this crosslinking silicone resin are excellent in water repellency, humidity resistance, and so forth. However, if the crosslinking structure is overly minute, the resin layer is likely to become brittle; therefore, it is important that the crosslinking silicone resin should be properly selected in view of its molecular weight.

A weight ratio (Si/C) between silicon and carbon in the crosslinking silicone resin is preferably 0.3 to 2.2.

If the ratio Si/C is less than 0.3, the resin layer may decrease in hardness, and life of the carriers may become shortened. If the ratio Si/C exceeds 2.2, a charge-adding property of the carriers toward the toner is likely to be affected by temperature changes, and the resin layer may become brittle.

Examples of the crosslinking silicone resin, which is commercially available, include products manufactured by Dow Corning Toray Co., Ltd., such as SR2400, SR2410, SR2411, SR2510, SR2405, 840RESIN, and 804RESIN, and products manufactured by Shin-Etsu Chemical Co., Ltd., such as KR350, KR271, KR272, KR274, KR216, KR280, KR282, KR261, KR260, KR255, KR266, KR251, KR155, KR152, KR214, KR220, X-4040-171, KR201, KR5202, and KR3093.

Used as the resin is preferably a silicone resin, especially a crosslinking silicone resin; and the resin may contain any of other resins as long as its desirable characteristics are not impaired.

Examples of the other resins include epoxy resins, urethane resins, phenol resins, acrylic resins, styrene resins, polyamides, polyesters, acetal resins, polycarbonates, vinyl chloride resins, polyvinyl acetate resins, cellulose resins, polyolefins, fluorine resins, copolymer resins thereof, and compounded resins; and of these resins, the acrylic resins are preferable because of high charging ability. To improve properties of the resin layer, such as humidity resistance and detachability, formed of the silicone resin (especially, the crosslinking silicone resin), the resin layer may contain bifunctional silicone oil.

### Magnetic Microparticles

Magnetic microparticles may contain the same material as the carrier cores.

The magnetic microparticles of the present invention have the above-described specific physical properties; however, the magnetic microparticles that do not have such physical properties can obtain these physical properties if these magnetic microparticles are subjected to a high-resistivity treatment such as a surface oxidation treatment.

One example of the surface oxidation treatment is flow oxidation to be carried out at 250 to 500° C. in an oxidant atmosphere, such as in the air.

The magnetic microparticles are preferably 0.05 to 0.8 μm in average particle diameter, and more preferably 0.08 to 0.5 μm.

The magnetic microparticles having the average particle diameter within the above-described range can be stably prevented from being eccentrically located in the resin layer and between the carriers during the formation of the resin layer on the surfaces of the carrier cores. Also, such magnetic microparticles do not bring about the formation of an uneven surface of the resin layer, resulting in a uniform resin layer. Although reason for this remains uncertain, it is conceivable that the metal oxide microparticles are retained uniformly because of a magnetic force among the metal oxide microparticles.

In a case where the magnetic microparticles as the raw material do not have the appropriate average particle diameter, the magnetic microparticles may be subjected to a milling treatment or a classifying treatment by use of any publicly known apparatus, such as a sand mill, before being subjected to the above-described high-resistivity treatment. The treatments will be specifically explained in Examples below.

A content of the magnetic microparticles is not particularly limited; however, their content is preferably 0.05 to 65 parts by weight with respect to 1,000 parts by weight of the carrier cores; and more preferably 0.5 to 40 parts by weight.

The magnetic microparticles having the content within the above-described range can exert excellent effects of the present invention.

Namely, the content of the magnetic microparticles in the resin layer is preferably 1 to 183 parts by weight with respect to 100 parts by weight of the resin; and more preferably 10 to 133 parts by weight.

If the content of the magnetic microparticles becomes lower than 1 part by weight, the magnetic microparticles may not exert the effects sufficiently. If the content of the magnetic microparticles exceeds 183 parts by weight, the resin layer may not be formed uniformly.

### Electrically Conductive Microparticles

It is preferable that the resin layer should contain electrically conductive microparticles.

The resin layer containing the electrically conductive microparticles is capable of improving charge-adding ability from the carriers to the toner in a more stable manner. Namely, the electrically conductive microparticles are unlikely to charge up the carriers.

The electrically conductive microparticles are not particularly limited; and any electrically conductive microparticles commonly used in the relevant technical field may be used, such as oxides including conductive carbon black, conductive titanium oxide, and conductive tin oxide.

The carbon black can develop electrical conductivity even if its content is low, and is suitable for a black toner. There is, however, apprehension that the carbon black may become detached from the resin layer; therefore, the conductive titanium oxide or the like doped with antimony is desirable as a color toner.

A content of the electrically conductive microparticles is not particularly limited; however, their content is preferably 1 to 25 parts by weight with respect to 100 parts by weight of the resin; and more preferably 1 to 20 parts by weight.

If the content of the electrically conductive microparticles becomes lower than 1 part by weight, the electrically conductive microparticles may not exert the effects. If the content of the electrically conductive microparticles exceeds 25 parts by weight, the resin layer may not be formed uniformly.

### Coupling Agent

The resin layer may contain the coupling agent such as a silane coupling agent for the purpose of adjusting an electrification amount of the toner.

It is preferable that the silane coupling agent should have an electron-releasing functional group; and one example of the silane coupling agent is an amino group-containing silane coupling agent represented by the following formula:

(Y)ₙSi(R)ₘ

wherein the substituents Rs may be the same or different and represent a C₁-C₄ alkyl group, a C₁-C₄ alkoxy group, or a chlorine atom; the substituents Ys may be the same or different and represent an amino group-containing C₁-C₁₀ saturated hydrocarbon and/or aromatic hydrocarbon group; and the subscripts m and n each are an integer of 1 to 3 and are designated as m+n=4.

In the above-described formula, examples of the alkyl group represented by R include linear or branched alkyl groups having 1 to 4 carbon atoms, such as methyl groups, ethyl groups, propyl groups, isopropyl groups, butyl groups, isobutyl groups, and tert-butyl groups; and the methyl groups are preferable among these groups.

Examples of the alkoxy group include linear or branched alkoxy groups having 1 to 4 carbon atoms, such as methoxy groups, ethoxy groups, propoxy groups, isopropoxy groups, butoxy groups, isobutoxy groups, and tert-butoxy groups; and the methoxy groups and the ethoxy groups are preferable among these groups.

Examples of the amino group-containing saturated hydrocarbon and/or aromatic hydrocarbon group represented by Y include —(CH₂)ₐ—X, wherein the substituent X represents an amino group, an aminocarbonyl amino group, an aminoalkyl amino group, a phenyl amino group, or a dialkyl amino group, and the subscript a is an integer of 1 to 4; and -Ph-X, wherein the substituent X represents the same as above, and the substituent -Ph- represents a phenylene group.

Specific examples of the amino group-containing silane coupling agent include the following:

H₂N(H₂C)₃Si(OCH₃)₃

H₂N(H₂C)₃Si(OC₂H₅)₃

H₂N(H₂C)₃Si(CH₃)(OCH₃)₂

H₂N(H₂C)₂HN(H₂C)₃Si(CH₃)(OCH₃)₂

H₂NOCHN(H₂C)₃Si(OC₂H₅)₃

H₂N(H₂C)₂HN(H₂C)₃Si(OCH₃)₃

H₂N-Ph-Si(OCH₃)₃ wherein the substituent -Ph- represents a p-phenylene group

Ph-HN(H₂C)₃Si(OCH₃)₃ wherein the substituent Ph- represents a phenyl group

(H₉C₄)₂N(H₂C)₃Si(OCH₃)₃

In the present invention, the above-described coupling agents may be used independently, or two or more kinds may be used in combination.

A content of the coupling agent is not particularly limited; however, its content is preferably 1 to 15 parts by weight with respect to 100 parts by weight of the resin; and more preferably 5 to 15 parts by weight.

The coupling agent having the content within the above-described range can give sufficient electric charge to the toner and is unlikely to cause a significant decrease in mechanical strength or the like of the resin layer.

### Preparation of Carriers

The carriers of the present invention may be prepared through the following steps: A liquid resin in which constituents of the above-described resin layer are dissolved or dispersed in a solvent is applied to surfaces of carrier cores; the solvent is then volatized and removed so as to form a coating layer; and the coating layer is heated and hardened, or simply hardened, during or after being dried.

The solvent is not particularly limited; and any solvent that dissolves the resin may be used. Examples of the solvent include aromatic carbon hydrides such as toluene and xylene; ketones such as acetone and methyl ethyl ketone; ethers such as tetrahydrofuran and dioxane; and organic solvents such as higher alcohols. The solvents may be used independently, or two or more kinds may be used in combination.

How to apply the liquid resin to the surfaces of the carrier cores may be adopted from any publicly known method. Examples of this method include a dipping method in which the carrier cores are immersed in the liquid resin; a spray method in which the liquid resin is sprayed on the carrier cores; a fluid bed method in which the liquid resin is sprayed on the carrier cores while the carrier cores float in the flowing air; and a kneader-coater method in which the carrier cores and the liquid resin are mixed in a kneader-coater, and the solvent is removed. Of these methods, the spray method is preferable since this method can minimize the exposure of the magnetic core particles.

The coating solution layer may be dried with use of a drying accelerator.

Used as the drying accelerator may be any of those publicly known as drying accelerators; and examples of the drying accelerator include metal soaps such as lead salt, iron salt, cobalt salt, manganese salt, and zinc salt containing naphthyl acid, octyl acid, or the like; and organic amines such as ethanolamine. The drying accelerators may be used independently, or two or more kinds may be used in combination. A content of the drying accelerator is of the order of 0.1 to 5 parts by weight with respect to 100 parts by weight of the solvent.

To harden the coating solution layer, a heating temperature may be properly determined depending on the type of the resin or the solvent; and the heating temperature may be, for example, of the order of 150 to 280° C. If a normothermic hardening silicone resin is used as the resin to be applied to the carrier core surfaces, this silicone resin may not be necessarily heated, but may be heated at about 150 to 280° C. for the purpose of improving a mechanical strength of the resin layer to be formed or shortening the hardening time.

A total solid concentration of the liquid resin is not particularly limited; however, the total solid concentration may be adjusted in such a way that the resin layer is hardened to be usually 5 μm or less in thickness, preferably about 0.1 to 3 μm, in consideration of coating applicability or the like of the liquid resin on the carrier cores.

It is preferable that the carriers obtained in this manner should have a high electrical resistance and should be in a spherical shape; however, even if the carriers are electrically conductive or are non-spherical, this does not ruin any effects of the present invention.

### Two-Component Developer

In the following, a two-component developer to contain the carriers of the present invention will be explained. The two-component developer is characterized by containing the toner of the present invention and the carriers, both of which are described above; and the two-component developer may be prepared by mixing the toner and the carriers by use of, for example, a mixer such as a Nauta mixer (trade name: VL-0, manufactured by Hosokawa Micron Corporation).

A ratio between the toner and the carriers is preferably a mass ratio of, for example, 10:90 to 5:95.

### Measuring Methods of Physical Properties

In the following, measuring methods of physical property values regarding the present invention will be explained.

Volume Average Particle Diameter of Toner 20 mg of toner particles and 1 ml of alkyl ether sulfuric ester sodium were added to 50 ml of an electrolytic solution (trade name: ISOTON-II, manufactured by Beckman Coulter, Inc.); and the mixture was subjected to a dispersion treatment for 3 min at a frequency of 20 kHz by use of an ultrasonic disperser (trade name: UH-50, manufactured by SMT Co., Ltd.) so as to obtain a sample for measurement. The obtained sample for measurement was measured under the following conditions by use of a particle size analyzer (trade name: Coulter Multisizer II, manufactured by Beckman Coulter, Inc.) to obtain a volume average particle diameter of a toner from volumetric size distribution of the sample particles: 100 μm of an aperture diameter and 50,000 particles.

### Measurements of Average Particle Diameters (μm) of Carrier Cores, Magnetic Microparticles, and Conductive Particles

About 10 to 15 mg of the sample for measurement was added to 10 mL of a 5% aqueous solution of ether-type non-ionic surfactant (polyoxy lauryl ether, HLB =13.6, manufactured by Kao Corporation, product name: Emergen 109P); and the mixture was subjected to a dispersion treatment for 1 min at a frequency of 20 kHz by use of an ultrasonic disperser (manufactured by SMT Co., Ltd., model number: UH-50). About 1 mL of the obtained dispersion liquid was measured for volumetric size distribution by use of a particle size analyzer (manufactured by Nikkiso Co., Ltd., model number: Micro Track MT3000) so as to obtain a volume average particle diameter from its result.

### Measurements of Volume Resistance Values of Carriers

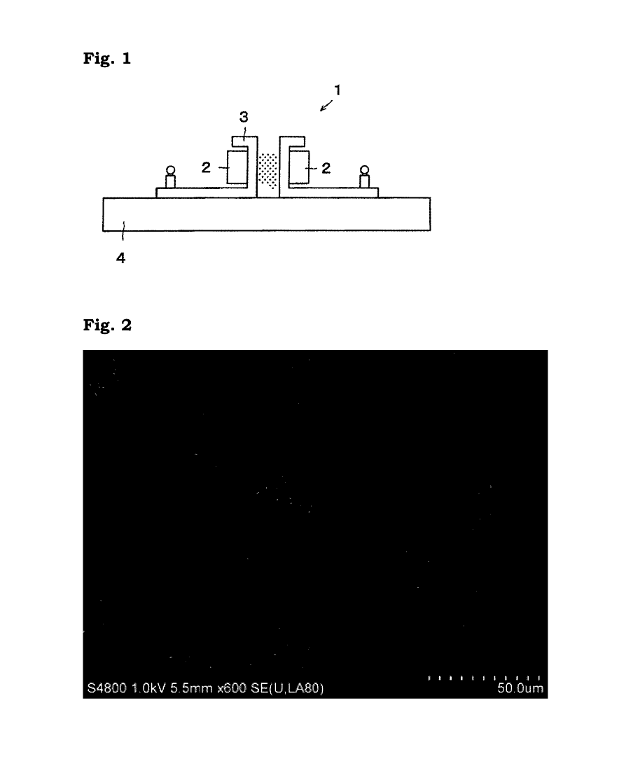

Volume resistance values of the magnetic microparticles may be measured at an electric field of 1,000 V/cm by use of a measuring jig as illustrated in FIG. 1. Namely, FIG. 1 is a schematic view of the measuring jig to be used for resistance value measurements of the magnetic microparticles.

The measuring jig 1 is formed of magnets 2, aluminum electrodes 3, and a substrate (acrylic resin plate) 4. The electrodes 3 are spaced 1 mm apart, and are formed of parallel plates, each of which has a size of 10 mm×40 mm.

200 mg of the magnetic microparticles were inserted into the space between these electrodes, and then the magnets 2 (a surface magnetic flux density of 1,500 gausses, and 10 mm×30 mm in magnetic area of the opposed surface) were placed in such a way that the north pole and the south pole were opposed to each other so as to retain the magnetic microparticles between the electrodes. Current values were measured at a time when a direct voltage was applied to the electrodes 3 under a 1 V step until reaching 1,000 V so as to calculate bridge resistance values, and these values were considered as volume resistance values of the magnetic microparticles.

Determination of Area Percentage of Parts Derived from Metal Oxide on Surfaces of Magnetic Carrier Particles

An area % of the parts derived from the metal oxide on the surfaces of the magnetic carrier particles of the present invention can be calculated by observing an electron image obtained by a scanning electron microscope and by subsequently carrying out image processing.

The area percentage of the parts derived from the metal oxide on the surfaces of the magnetic carrier particles of the present invention was determined by a scanning electron microscope (SEM)-S-4800 (manufactured by Hitachi, Ltd.). The area percentage of the parts derived from the metal oxide can be calculated by the image processing of a visualized image mainly of reflected electrons under an accelerating voltage of 1.0 kV.

To be more specific, the carrier particles were fixed on a stage of the scanning electron microscope by use of a carbon tape in such a way that the carrier particles were spread out to be singled-layered without carrying out platinum-using vapor deposition; and the carrier particles were observed by use of the scanning electron microscope S-4800 (manufactured by Hitachi, Ltd.) under the following conditions. The observation was carried out under the following measuring conditions after a flashing operation was conducted:

Signal name=SE (U, LA80)

Accelerating voltage=2,000 volts

Emission current=10,000 nA

Working distance=6,000 μm

Lens mode=high

Condenser 1=5

Scan speed=slow 4 (40 sec)

Magnification=600

Data size=1,280×960

Color mode=gray scale

The reflected-electron image was adjusted by control software of the scanning electron microscope S-4800 to set brightness of the image to “contrast 5 and brightness 5”; and a projection image of the magnetic carriers was obtained through “slow 4 for 40 sec” of capture speed/integrating sheets and as a 256-level gray-scale image of 1,280×960 pixels with 8 bits (see FIG. 2). The following results were obtained in view of the scale of the image: 0.1667 μm in length of one pixel, and 0.0278 μm² in area of the one pixel.

Following that, an area percentage (area %) of parts derived from the metal oxide was calculated from fifty (50) magnetic carrier particles by use of the obtained projection image of the reflected electrons. How the fifty (50) magnetic carrier particles to be analyzed were selected will be described below in detail. The area % of the parts derived from the metal oxide was calculated by using image processing software—Image-Pro Plus 5.1J (manufactured by Media Cybernetics, Inc.)

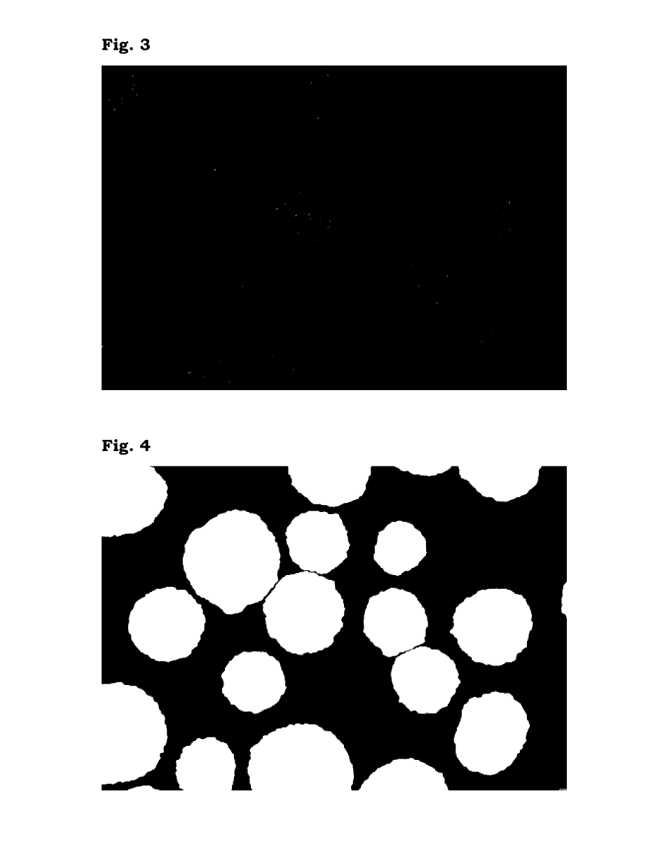

First of all, since the image of FIG. 2 had an unneeded string of letters at its bottom, the unneeded portion was cut off, obtaining the image having a size of 1,280×895 (see FIG. 3).

Then the parts of the magnetic carrier particles were extracted, and a size of the extracted magnetic carrier particle parts was measured. More specifically, the magnetic carrier particles were separated from the background image in order to extract the magnetic carrier particles to be analyzed. By using the image processing software—Image-Pro Plus 5.1J, the following procedures were taken: click “Measurement” and then “Count/Size”; go to “Brightness Range Selection” under the “Count/Size” section; and set a brightness range from 50 to 255 so as to remove a low-brightness carbon tape part where is shown as the background and to extract the magnetic carrier particles (see FIG. 4).

In a case where the magnetic carrier particles are fixed by use of something else other than the carbon tape, the background may not necessarily be low in brightness, or may be partly the same in brightness as the magnetic carrier particles. A borderline between the magnetic carrier particles and the background, however, is distinguishable from the reflected-electron image by observation. To extract the magnetic carrier particles, the following procedures were taken: select 4-linkage in extracting options under the “Count/Size” section, enter smoothness 5, and place a checkmark in a checkbox indicating “Filling in Holes”; and the particles sitting on an outline (outer periphery) of the image and the particles overlapping one another were considered to be excluded from the calculation. One particle was selected from the group of the extracted particles, and an area (number of pixels) of parts derived from this particle was calculated.

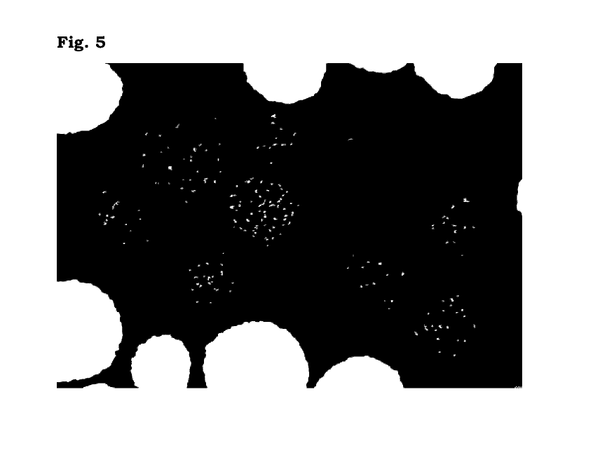

Next, the following procedures were taken by using the software—Image-Pro Plus 5.1J: go to “Brightness Range Selection” under the “Count/Size” section, and set a brightness range from 140 to 255 so as to extract parts where are high in brightness on the carrier particles (see FIG. 5). An area selection range was determined to be 10 pixels at the minimum and to be 10,000 pixels at the maximum.

A total area (number of pixels) of parts derived from the metal oxide on the surfaces of the magnetic carrier particles selected earlier was calculated.

A percentage of the magnetic carrier particles was calculated in which the percentage of the total area of the high-brightness parts derived from the metal oxide on one magnetic carrier particle to the total projected area was 3.0% by area at the maximum.

Next, each particle of the group of the extracted particles was subjected to the same treatment until the number of the magnetic carrier particles to be selected became fifty (50). If the number of the particles looked at from one side of the view did not reach fifty (50), the projection image of the magnetic carrier particles looked at from another side of the view was subjected to the same treatment.

Then an average percentage of the total area of the high-brightness parts derived from the metal oxide on the magnetic carrier particles to the total projected area of the magnetic carriers was calculated.

### EXAMPLES

In the following, the present invention will be explained in detail through the use of Examples; however, the present invention should not be limited to these Examples.

### Preparation Example 1

Preparation of Amorphous Polyester Resin PA1

To a reaction vessel, 440 g of terephthalic acid (2.7 mol), 235 g of isophthalic acid (1.4 mol), 7 g of adipic acid (0.05 mol), 554 g of ethylene glycol (8.9 mol), and 0.5 g of tetrabutoxytitanate as a polymerization catalyst were introduced; and the mixture was allowed to react for 5 hours while water and ethylene glycol were distilled away from the mixture at 210° C. in a nitrogen stream, and then allowed to react under reduced pressure of 5 to 20 mmHg for 1 hour. Then 103 g of trimellitic anhydride (0.54 mol) was added; and the mixture was allowed to react at normal pressure for 1 hour and to react under reduced pressure of 20 to 40 mmHg so as to collect a resin at a predetermined softening point. An amount of the collected ethylene glycol was 219 g (3.5 mol).

The obtained resin was cooled to room temperature and then was ground to particles. These particles were determined as an amorphous polyester resin PA1. The amorphous polyester resin PA1 resulted in T_{g} of 56° C., Tₘ of 135° C., Mₚ of 4,800, acid value of 37 mg KOH/g, and hydroxyl value of 50 mg KOH/g.

### Preparation Example 2

Preparation of Crystalline Polyester Resin PC1

To a reaction vessel, 132 g of 1,6-hexanediol (1.12 mole), 230 g of 1,10-decane dicarboxylic acid (1.0 mol), and 3 g of tetrabutoxytitanate as a polymerization catalyst were introduced; and the mixture was allowed to react for 5 hours while water was distilled away from the mixture at 210° C. at normal pressure. The reaction was allowed continuously under reduced pressure of 5 to 20 mmHg, and a resin was collected at a time when an acid value reached to lower than 2 mg KOH/g. The obtained resin was cooled to room temperature and was ground to particles. These particles were determined as a crystalline polyester resin PC1. The crystalline polyester resin PC1 resulted in Tₘₚ of 66° C., Tₘ of 73° C. (Tₘ/Tₘₚ=1.1), and Mₚ of 13,500.

### Preparation Example 3

### Preparation of Toner T1

| | |
|---|---|
| Amorphous polyester resin PA1 | 95 parts by mass |
| Crystalline polyester resin PC1 | 5 parts by mass |
| Wax (WEP-5, manufactured by NOF Corporation) | 5 parts by mass |
| Carbon black (MA-100, manufactured by Mitsubishi | 7 parts by mass |
| Chemical Corporation) | |
| Charge-controlling agent (Bontron E-84, | 1 part by mass |
| manufactured by Orient Chemical Industries Co., Ltd.) | |

The above-listed toner materials were stirred and mixed for 5 minutes by use of a Henschel mixer (FM20C, manufactured by Nippon Coke & Engineering Co., Ltd.), and the obtained stirred mixture was melted and kneaded by use of an open roll continuous kneader (MOS 320-1800, manufactured by Mitsui Mining Co., Ltd.).

The obtained molten-kneaded mixture was cooled by a cooling belt, and was coarsely milled by use of a speed mill having a φ 2-mm screen; the coarse particles were then finely milled by use of a jet milling machine (IDS-2, manufactured by Nippon Pneumatic Mfg. Co., Ltd.); and the fine particles were classified by use of an elbow-jet classifier (manufactured by Nittetsu Mining Co., Ltd., model number: EJ-LABO) so as to obtain toner base particles having a volume average particle diameter of 6.5 μm.

To 100 parts by mass of the obtained toner base particles, the following two silica microparticles were added as external additives: 2 parts by mass of silica microparticles (100 nm in average particle diameter) hydrophobized with i-butyltrimethoxysilane, and 1.5 parts by mass of commercially available silica microparticles (trade name: R976, manufactured by Nippon Aerosil Co. Ltd., 7 nm in average primary particle diameter); and the mixture was stirred for 2 min by use of an airflow mixer (manufactured by Mitsui Mining Co., Ltd., Henschel mixer) whose agitating blades were programmed to spin at a tip speed of 15 m/sec so as to prepare a toner T1 having a volume average particle diameter of 6.5 μm.

### Preparation Example 4

### Preparation of Toner T2

A toner T2 was obtained in the same manner as the preparation of the toner T1 except that C.I. Pigment Blue 15:3 was used as a colorant instead of the carbon black.

### Preparation Example 5

### Preparation of Toner T3

A toner T3 was obtained in the same manner as the preparation of the toner T1 except that the following resins were used as binder resins:

| | |
|---|---|
| Amorphous polyester resin PA1 | 80 parts by mass |
| Crystalline polyester resin PC1 | 20 parts by mass |

### Preparation Example 6

### Preparation of Carriers C1

100 parts by weight of a silicone resin (number average molecular weight: about 15,000), 3 parts by weight of carbon black (25 nm in primary particle diameter, 150 ml/100 g of oil absorption) as an electrical conducting material, 8 parts by weight of a silane coupling agent (100% solution, manufactured by Dow Corning Toray Co., Ltd., product name: Z6011) as a charge-controlling agent, 20 parts by weight of magnetite (0.28 μm in average primary particle diameter, 5.5 m²/g in specific surface area, 52 Oe in coercive force, 5.2 in absolute specific gravity) as magnetic microparticles, and 5 parts by weight of octylic acid as a curing agent were dissolved and dispersed in toluene to prepare a coating liquid for covering. The prepared coating liquid for covering was applied to 1,000 parts by weight of carrier cores (Mn—Mg ferrite) having an average particle diameter of 45 μm by use of a spray covering device. The toluene was completely evaporated and removed; and carriers C1 were prepared having a volume average particle diameter of 45 μm, a volume resistivity of 2×1011 Ω·cm, and a saturated magnetization of 65 emu/g.

### Preparation Examples 7 to 12

### Preparations of Carriers C2 to C7

Resin-covered carriers C2 to C7 were obtained in the same manner as the preparation of the resin-covered carriers C1 except that the following components and their contents were used as shown in Table 1 below.

TABLE 1

| | | Parts by wt of | Parts by wt of |
|---|---|---|---|
| | Carriers | silicone resin | aminopropyltriethoxysilane |
| Prep Ex 6 | C1 | 100 | 8 |
| Prep Ex 7 | C2 | 125 | 8 |
| Prep Ex 8 | C3 | 150 | 8 |
| Prep Ex 9 | C4 | 100 | 4 |
| Prep Ex 10 | C5 | 125 | 4 |
| Prep Ex 11 | C6 | 150 | 4 |
| Prep Ex 12 | C7 | 60 | 8 |

### Preparation Example 13

### Preparation of Carriers C8

100 parts by weight of a silicone resin (number average molecular weight: about 15,000), 3 parts by weight of carbon black (25 nm in primary particle diameter, 150 ml/100 g of oil absorption) as an electrical conducting material, 8 parts by weight of a silane coupling agent (100% solution, manufactured by Dow Corning Toray Co., Ltd., product name: Z6011) as a charge-controlling agent, 20 parts by weight of magnetite (0.28 μm in average primary particle diameter, 5.5 m²/g in specific surface area, 52 Oe in coercive force, 5.2 in absolute specific gravity) as magnetic microparticles, and 5 parts by weight of octylic acid as a curing agent were dissolved and dispersed in toluene to prepare a coating liquid for covering.

This coating liquid for covering and 1,000 parts by weight of carrier cores (Mn—Mg ferrite) having an average particle diameter of 45 μm were introduced into a vacuum de-airing kneader and stirred at 60° C. for 25 min, and then the mixture was heated and depressurized to be de-aired and dried so as to prepare carriers C8 having a volume average particle diameter of 45 μm, a volume resistivity of 1.5×1011 Ω·cm, and a saturated magnetization of 65 emu/g.

### Preparation Examples 14 and 15

### Preparations of Carriers C9 and Carriers C 10

Resin-covered carriers C9 and carriers C10 were obtained in the same manner as the preparation of the resin-covered carriers C8 except that the following components and their contents were used as shown in Table below.

TABLE 2

| | | Parts by wt of | Parts by wt of |
|---|---|---|---|
| | Carriers | silicone resin | aminopropyltriethoxysilane |
| Prep Ex 13 | C8 | 100 | 8 |
| Prep Ex 14 | C9 | 125 | 8 |
| Prep Ex 15 | C10 | 150 | 8 |

### Example 1

### Preparation of a Two-Component Developer D1

The toner T1 (A) and the carriers C1 (B) in a 6:94 mass ratio (A:B) were introduced into a Nauta mixer (trade name: VL-0, manufactured by Hosokawa Micron Corporation), and stirred and mixed for 20 min so as to prepare a two-component developer D1 of Example 1.

### Examples 2 to 7 and Comparative Examples 1 to 3

### Preparations of Two-Component Developers D2 to D10 and Their Evaluations

Two-component developers D2 to D10 of Examples 2 to 7 and Comparative Examples 1 to 3 were prepared in the same manner as in Example 1 except that the following toners and resin-covered carriers were combined as shown in Table 3, and the results were evaluated.

### Evaluation Method of Ghost Phenomenon

A developing unit and a toner cartridge of a color copying machine (trade name: MX-4140FN, manufactured by Sharp Corporation) were filled with the prepared two-component developer and the toner; and continuous print tests were carried out by use of 50,000 sheets of paper in an environment at 25° C. and at 50% humidity in such a way that a square-shaped solid image (ID=1.45 to 1.50), 1 cm on each side, comes to be formed at a position with three points—a central part and both ends in an axis direction of a developing roller.

Evaluation standards of a ghost phenomenon are as follows.

In a case where print patterns of a print image on the 50,000th sheet at the first rotation of a developing sleeve appeared as ghosts after the second rotation or thereafter, the number of the ghosts was counted; and a ghost phenomenon was evaluated from the ghost numbers on the basis of the following standards.

A: Very good. (There is no ghost.)

B: Good. (There is one ghost.)

C: Acceptable. (There are two ghosts.)

D: Unacceptable. (There are three or more ghosts.)

TABLE 3

| | | | | Percentage of particles | Area percentage of parts | |
|---|---|---|---|---|---|---|
| | | | | whose parts derived from | derived from metal oxide | |
| | | | | metal oxide is 3.0% by area | on surfaces of magnetic | Ghost |
| | Toner | Carriers | Developer | at the maximum (% by piece) | carrier particles | phenomenon |
| Ex 1 | T1 | C1 | D1 | 98.3 | 0.4 | A |
| Ex 2 | T1 | C2 | D2 | 97.1 | 0.3 | A |
| Ex 3 | T2 | C3 | D3 | 98.6 | 0.7 | A |
| Ex 4 | T2 | C4 | D4 | 96.3 | 0.5 | B |
| Ex 5 | T3 | C5 | D5 | 96.0 | 0.2 | B |
| Ex 6 | T3 | C6 | D6 | 98.5 | 0.4 | B |
| Ex 7 | T1 | C7 | D7 | 82.1 | 1.9 | B |
| Comp Ex 1 | T1 | C8 | D8 | 16.8 | 6.4 | D |
| Comp Ex 2 | T1 | C9 | D9 | 19.1 | 5.9 | D |
| Comp Ex 3 | T1 | C10 | D10 | 22.3 | 4.2 | D |

It was found from the above-described results of the two-component developers D1 to D7 obtained in Examples 1 to 7 that there was no ghost phenomenon or only one ghost phenomenon in the case where the percentage of the particles, whose parts derived from the metal oxide were 3.0% by area at the maximum, to the total projected area of the one magnetic carrier particle was 80% by piece or more and where the area percentage of the parts derived from the metal oxide on the surfaces of the magnetic carrier particles was 3.0% by area or less, leading to the excellent two-component developers.

In the meanwhile, it was found from the results of Comparative Examples 1 to 3 that there were three or more ghost phenomena in the case where the percentage of the particles having 3.0% by area at the maximum was 30% by piece and where the area percentage of the parts derived from the metal oxide on the surfaces of the magnetic carrier particles was 3.5% by area or more, with the result that the two-component developers were unusable.

The present invention can provide the carriers-containing two-component developers excellent in low-temperature fixability, the carriers being used for developing an electrostatic latent image.

What is claims is:

1. A two-component developer constituted of a toner and carriers, wherein the toner contains a crystalline polyester resin, constituted of a linear saturated aliphatic polyester unit, dispersed in an amorphous polyester resin obtained by polymerizing a bivalent alcohol component monomer and a dicarboxylic acid as an acid component monomer;
wherein the carriers have a magnetic property and have core particles covered with a covering layer containing at least a binder resin and aminopropyltriethoxysilane; and
wherein an image of the magnetic carriers photographed by a scanning electron microscope shows the following features:
a percentage of a total area of high-brightness parts derived from a metal oxide on the one magnetic carrier particle to a total projected area is 3.0% by area at the maximum and 80% by piece in the magnetic carriers at the minimum and
an average percentage of the total area of the high-brightness parts derived from the metal oxide on the magnetic carrier particle to the total projected area of the magnetic carriers is 3.0% by area at the maximum.

2. The two-component developer according to claim 1 wherein the bivalent alcohol is ethylene glycol as a main component.

3. The two-component developer according to claim 1 wherein a content of aminopropyltriethoxysilane contained in the surface resin layer of the carriers is 1 to 15 parts by weight with respect to 100 parts by weight of the resin.

4. The two-component developer according to claim 1 wherein an image of the magnetic carriers photographed by the scanning electron microscope shows the following features:
a percentage of a total area of high-brightness parts derived from a metal oxide on one magnetic carrier particle to a total projected area is 3.0% by area at the maximum and 90% by piece in the magnetic carriers at the minimum and
an average percentage of the total area of the high-brightness parts derived from the metal oxide on the magnetic carrier particle to the total projected area of the magnetic carriers is 3.0% by area at the maximum.

5. The two-component developer according to claim 1 wherein a content of aminopropyltriethoxysilane contained in the surface resin layer of the carriers is 5 to 15 parts by weight with respect to 100 parts by weight of the resin.

6. Carriers having core particles covered with a covering layer containing at least a binder resin and aminopropyltriethoxysilane,
wherein an image of the magnetic carriers photographed by a scanning electron microscope shows the following features:
a percentage of a total area of high-brightness parts derived from a metal oxide on one magnetic carrier particle to a total projected area is 3.0% by area at the maximum and 80% by piece in the magnetic carriers at the minimum and
an average percentage of the total area of the high-brightness parts derived from the metal oxide on the magnetic carrier particle to the total projected area of the magnetic carriers is 3.0% by area at the maximum.
